(19) United States
(12) Patent Application Publication
(10) Pub. No.: US 2019/0303812 A1
(43) Pub. Date: Oct. 3, 2019

(54) WORKFLOW SYSTEM AND METHOD OF WORKFLOW CONTROL

(71) Applicant: Honda Access Corp., Niiza-shi (JP)

(72) Inventor: Fumihiko Kato, Niiza-shi (JP)

(73) Assignee: Honda Access Corp., Niiza-shi (JP)

(21) Appl. No.: 16/369,273

(22) Filed: Mar. 29, 2019

(30) Foreign Application Priority Data
Mar. 29, 2018 (JP) 2018-065641

(51) Int. Cl. G06Q 10/06; G06F 9/448

(52) U.S. Cl. CPC G06Q 10/06; G06Q 50/00; G06F 9/448

(57) ABSTRACT

In a workflow system that is configured from a server and a client and that performs via a network a job that has been set arbitrarily combining an operation flow and an approval application flow, a concurrent number of the operation flows that can be concurrently set in one workflow is arbitrarily set by the client.

### CROSS-REFERENCE TO RELATED APPLICATION

This application is based upon and claims the benefit of priority from Japanese Patent Application No. 2018-065641 filed on Mar. 29, 2018, the contents of which are incorporated herein by reference.

### BACKGROUND OF THE INVENTION

### Field of the Invention

The present invention relates to a workflow system and a method of workflow control that process via a network a job that has been set arbitrarily combining an operation flow and an approval application flow being sub-flows of a workflow.

### Description of the Related Art

Japanese Laid-Open Patent Publication No. 2009-069876 describes a workflow system, a method of workflow control, and a program that, based on various kinds of definition information and their setting values, execute parallel flow control and/or series flow control based on a job processing and generate a screen used during execution of the parallel flow control and/or the series flow control without generating program source code, and are thereby capable of facilitating resource management of a system and of being generally applied to a plurality of job systems.

### SUMMARY OF THE INVENTION

Incidentally, in Japanese Laid-Open Patent Publication No. 2009-069876, there is a description related to, for example, an application processing requiring approval of a superior (a vacation application), but there is no description of another processing, for example, a processing related to a job including an operation request.

In a manufacturer, and so on, a variety of operations (drawing creation, work schedule creation, and so on) by a plurality of persons frequently occur. There is currently no workflow system that executes a job processing including such a variety of operations, in addition to an application processing.

The present invention was made in view of the above-described kind of problem and has an object of providing a workflow system and a method of workflow control that can execute a job processing including such a variety of operations, in addition to an application processing, and that contributes to job furtherance of the likes of a manufacturer, for example.

[1] A workflow system according to a first present invention is a workflow system that is configured from a server and a client and that performs via a network a job processing that includes a workflow that has been set arbitrarily combining an operation flow and an approval application flow, the workflow system including: a workflow definition information storage section that stores workflow definition information defining information for controlling the workflow; a form definition information storage section that stores form definition information defining a plurality of forms employed by the workflow; a process instance storage section that stores process information generated by execution of the workflow; and a workflow control unit that executes the workflow, based on the workflow definition information and the process information, the workflow system storing in a form information storage section form information generated based on the form definition information, according to a constituent element and a property of a screen set by the client, the workflow control unit being capable of managing an operation situation performed by the workflow, and a concurrent number of the operation flows that can be concurrently set in one workflow being able to be arbitrarily set by the client.

As a result, a concurrent number of operation flows whose operations are simultaneously advanced by a plurality of operators (designers, and so on) can be arbitrarily set by a client, so an application range of a processing flow can be extended to various jobs, and a contribution is made to improving job furtherance.

[2] In the first present invention, the operation flow and the approval application flow may be set by combining in an arbitrary order preset sub-flows.

As a result, by combining in an arbitrary order approval application flows and the operation flows whose operations are simultaneously advanced by the plurality of operators (designers, and so on), a workflow can be constructed in accordance with various approvals or operations implemented by a product design, for example.

[3] A workflow system according to a second present invention is a workflow system that is configured from a server and a client and that executes via a network a job processing that includes a plurality of workflows, the server including: a workflow definition information storage section that stores workflow definition information defining a flow processing for executing the workflow of the job processing; a form definition information storage section that stores form definition information defining a constituent element of a screen displayed to the client during execution of the workflow; a process instance storage section that stores process information generated by execution of the workflow; a form input content storage section that stores item input information based on the constituent element of the screen inputted by the client during execution of the workflow; a workflow control unit that executes the workflow, based on the workflow definition information and the process information; a screen generation unit that generates, based on the form definition information, the process information, and the item input information, screen information of the screen of which display is requested during execution of the workflow, every time display of the screen is requested; and a workflow screen control unit that receives the item input information that has been inputted by the client, and provides the item input information to the screen generation unit, the workflow definition information having included in an end processing of at least one workflow of the plurality of workflows, an activation processing of another workflow of the plurality of workflows.

Conventionally, a technique in which an approval application such as a vacation application, or the like, is performed individually, a technique in which approval applications are continued in series, and a technique in which one approval application is selected from a plurality of approval applications by an XOR junction have been main techniques, and expectations have not extended to processing flows (operation flows) whose operations are simultaneously advanced by a plurality of operators (designers, and so on).

In the present embodiment, by arbitrarily combining with the approval application flows the operation flows whose operations are simultaneously advanced by the plurality of operators (designers, and so on), the application range of the processing flow can be extended to various jobs, and a contribution is made to improving job furtherance.

[4] In the second present invention, the plurality of workflows may include at least one approval application flow and at least one operation flow having a plurality of operations concurrently implemented.

It becomes possible that, for example, an approval application for implementing a design of a certain product is made, that, at a stage when approval has been granted, an operation request (for example, a request for creation of a design drawing, or the like) can be made to a plurality of operators (designers, and so on), and that, for example, a processing from a design approval to a request for creation of a design drawing is executed by one workflow.

[5] In the second present invention, the at least one operation flow and the at least one approval application flow may be combined in an arbitrary order. It becomes possible that a processing from an operation request (for example, a request for creation of a design drawing, or the like) being made to a plurality of operators (designers, and so on) to a subsequent application for verification or approval of a completed design drawing, for example, is executed by one workflow.
[6] In the second present invention, the workflow definition information may have included in an end processing of the approval application flow an activation processing of the operation flow. As a result, it becomes possible that the operation flow can be implemented after end of the approval application flow, and that the above-mentioned processing from design approval to the request for creation of the design drawing, for example, is executed by one workflow.
[7] In the second present invention, the workflow definition information may have included in an end processing of the operation flow an activation processing of the approval application flow. As a result, it becomes possible that the approval application flow can be implemented after end of the operation flow, and that the above-mentioned processing from the operation request (for example, the request for creation of the design drawing, or the like) being made to the plurality of operators (designers, and so on) to the subsequent application for verification or approval of the completed design drawing, for example, is executed by one workflow.
[8] In the second present invention, the workflow definition information may have included in an end processing of a first approval application flow an activation processing of the operation flow, and may have included in an end processing of the operation flow an activation processing of a second approval application flow.

As a result, it becomes possible that a processing from an approval application for implementing a design of a certain product being made, an operation request (for example, a request for creation of a design drawing, or the like) being made to a plurality of operators (designers, and so on) at a stage when approval has been granted, through to an application for verification or approval of a completed design drawing, for example, is executed by one workflow.

[9] In the second present invention, the operation flow may have a deadline set and may have an end processing implemented at a stage when the deadline has elapsed.

It becomes possible that a processing such as where if, at a stage when a deadline has elapsed, an operation has ended, then, for example, an approval application on a resulting item of the operation is implemented, as a normal end, and if, at the stage when the deadline has elapsed, the operation is incomplete, then a subsequent approval application, or the like, is not implemented, as an abnormal end, or the like, is executed by one workflow.

[10] In the second present invention, the operation flow may have an end processing implemented at a stage when each of the concurrently implemented plurality of operations has ended. It becomes possible that a processing such as where if a time point when an operation has ended is within a deadline, then, for example, an approval application on a resulting item of the operation is implemented, as a normal end, and if the time point when the operation has ended is exceeding the deadline, then a subsequent approval application, or the like, is not implemented, as an abnormal end, or the like, is executed by one workflow.
[11] A method of workflow control according to a third present invention is a method of workflow control that is configured from a server and a client and that performs via a network a job that has been set arbitrarily combining an operation flow and an approval application flow, the method of workflow control including the steps of: storing workflow definition information defining information for controlling a workflow; storing form definition information defining a plurality of forms employed by the workflow; storing process information generated by execution of the workflow; and executing the workflow, based on the workflow definition information and the process information, and furthermore, the method of workflow control including the steps of: storing in a form information storage section form information generated based on the form definition information, according to a constituent element and a property of a screen set by the client; and a concurrent number of the operation flows that can be concurrently set in one workflow being arbitrarily set by the client.
[12] A method of workflow control according to a fourth present invention is a method of workflow control that is configured from a server and a client and that executes via a network a job processing that includes a plurality of workflows, including the steps of: storing workflow definition information defining a flow processing for executing the workflow of the job processing; storing form definition information defining a constituent element of a screen displayed to the client during execution of the workflow; storing process information generated by execution of the workflow; storing item input information based on the constituent element of the screen inputted by the client during execution of the workflow; executing the workflow, based on the workflow definition information and the process information; generating, based on the form definition information, the process information, and the item input information, screen information of the screen of which display is requested during execution of the workflow, every time display of the screen is requested; and receiving the item input information that has been inputted by the client, and providing the item input information, the workflow definition information having included in an end processing of at least one workflow of the plurality of workflows, an activation processing of another workflow of the plurality of workflows.

The workflow system and the method of workflow control according to the present invention make it possible to execute a job processing including such a variety of operations, in addition to an application processing, and to contribute to job furtherance of the likes of a manufacturer, for example.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a workflow system according to the present embodiment;

FIG. 2 is a view for explaining a method for generating a software screen according to the present embodiment;

FIG. 3A is a view in which a flow processing of an approval application is expressed by business process modelling notation (BPMN), and FIG. 3B is a view in which a flow processing of an operation request is expressed by BPMN;

FIG. 4 is a view in which a flow processing of one typical job processing is expressed by BPMN;

FIG. 5 is an explanatory diagram showing examples of pieces of job processing configured by combining various sub-flows;

FIG. 6A is an explanatory diagram showing, as one example, designers, and so on, belonging to a first design section, and FIG. 6B is an explanatory diagram showing, as one example, designers, and so on, belonging to a second design section;

FIG. 7A is an explanatory diagram showing an example of an approval application form of a product design for the first design section, and FIG. 7B is an explanatory diagram showing an example of an approval application form of a product design for the second design section;

FIG. 8A is an explanatory diagram showing an example of a request form for creation of a design drawing of a product for the first design section, and FIG. 8B is an explanatory diagram showing an example of a request form for creation of a design drawing of a product for the second design section;

FIG. 9A is an explanatory diagram showing an example of an approval application form of a design drawing of the first design section;

FIG. 9B is an explanatory diagram showing an example of an approval application form of a design drawing of the second design section;

FIG. 10 is a flowchart showing a creation procedure of an application form and a request form by to a form creation tool;

FIG. 11 is a flowchart showing a creation procedure of a flow processing of one job processing A;

FIG. 12 is BPMN showing one example of an end processing of an approval application flow of a design;

FIG. 13 is BPMN showing one example of a first end processing of an operation request flow;

FIG. 14 is BPMN showing one example of a second end processing of an operation request flow;

FIG. 15 is (part one of) a flowchart showing a procedure of a documentation application of a workflow;

FIG. 16 is (part two of) a flowchart showing a procedure of a documentation application of a workflow; and

FIG. 17 is a flowchart showing an approval operation procedure of a design approval application or design drawing approval application for which application has been made.

### DESCRIPTION OF THE PREFERRED EMBODIMENTS

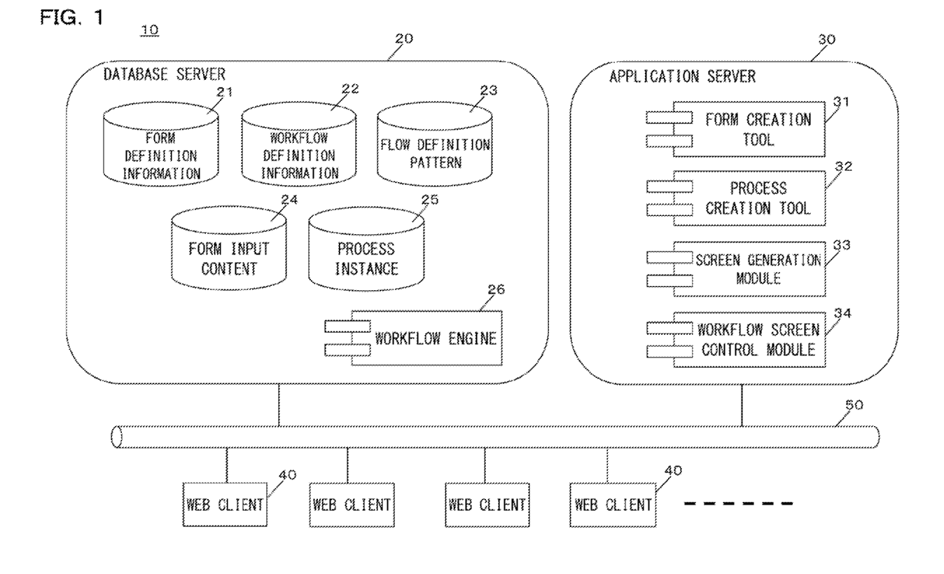

An embodiment of a workflow system and a method of workflow control according to the present invention will be described below with reference to FIGS. 1 to 17.

As shown in FIG. 1, a workflow system 10 according to the present embodiment has a configuration in which a database server 20, an application server 30, and a WEB client 40 are connected so as to be capable of communicating with each other via a network 50. The WEB client 40 is a terminal device used by a user, for example, and performs the likes of an approval application or operation request by creating a design of an application form or request form used by a workflow, for example.

The database server 20 includes the likes of a form definition information storage section 21, a workflow definition information storage section 22, a flow definition pattern storage section 23, a form input content storage section 24, a process instance storage section 25, and a workflow engine 26.

The form definition information storage section 21 stores form definition information defining a constituent element of a screen displayed to the WEB client 40 during workflow execution. The workflow definition information storage section 22 stores workflow definition information defining a flow processing for executing a workflow of a job processing. The flow definition pattern storage section 23 stores flow definition pattern information pre-defining information of the flow processing that a certain job processing has been patterned.

The form input content storage section 24 stores item input information based on the constituent element of the screen inputted by the WEB client 40 during execution of the workflow. The process instance storage section 25 stores process information (a process instance) generated by execution of the workflow.

The workflow engine 26 executes parallel flow control and/or series flow control of the workflow, based on the workflow definition information and the process instance, during workflow execution.

The application server 30 includes a form creation tool 31, a process creation tool 32, a screen generation module 33, and a workflow screen control module 34.

The form creation tool 31 selects a component required in the workflow from among a pre-prepared plurality of components (for example, an icon for inputting a character string, a numerical value, and so on), and, assuming the selected component to be a constituent element of the screen, sets its property information (information related to the component such as name, display size, and so on) and disposition information (information related to a display position on the screen). In addition, the form creation tool 31 generates form definition information, based on the set property information and disposition information of the constituent element, and stores the generated form definition information in the form definition information storage section 21. Moreover, the form creation tool 31 secures on the database server 20 the form input content storage section 24 associated with the generated form definition information.

For example, when, due to execution of the form creation tool 31, form definition information A is stored in the form definition information storage section 21, one form input content storage section 24-A associated with the form definition information A is secured on the database server 20. Therefore, when n items of form definition information are stored in the form definition information storage section 21, n form input content storage sections 24 are secured on the database server 20.

The process creation tool 32, in the case where there is one flow processing, sets an end processing of that flow processing, and in the case where a plurality of pieces of flow processing are connected in series, sets an end processing of a front stage flow and an end processing of a rear stage flow, for example. Reporting an approval result to a person concerned (an applicant, and so on) in the case of an approval application flow, for example, may be cited as an end processing of a flow processing.

Notifying the person concerned of activation of the rear stage flow processing, and so on, may be cited as an end processing of the front stage flow processing. These pieces of flow processing are patterned based on the pre-set flow definition pattern information to be stored in the workflow definition information storage section 22 as new workflow definition information.

Moreover, the process creation tool 32 generates workflow definition information based on the set flow processing, and stores the generated workflow definition information in the workflow definition information storage section 22.

The screen generation module 33 generates, based on the form definition information, the process information, and the item input information, screen information of the screen used during execution of the workflow, every time display of the screen is requested.

Moreover, the screen generation module 33 performs a logic check of the item input information inputted from the WEB client 40, due to execution of the workflow, and stores normal item input information in the form input content storage section 24. For example, if “34 March” is inputted as a date, this is judged to be a logic error.

The screen generation module 33 outputs to the workflow engine 26 a request to start execution of the workflow. In addition, the screen generation module 33 stores in the process instance storage section 25 the process information generated by execution of the workflow.

The workflow screen control module 34 displays to the WEB client 40, via a browser, a screen based on screen information generated by the screen generation module 33. In addition, the workflow screen control module 34 receives the item input information inputted by the user via the WEB client 40. Moreover, the workflow screen control module 34 provides the screen generation module 33 with the item input information received from the WEB client 40.

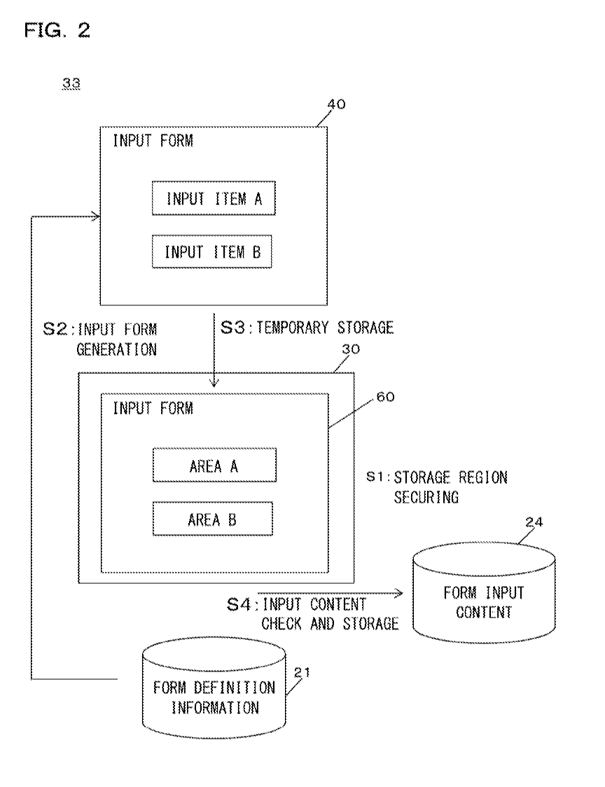

Next, a method for generating a software screen operating in a WEB environment will be described with reference to FIG. 2. FIG. 2 is a view for explaining the method for generating the software screen according to the present invention.

In step S1 of FIG. 2, the screen generation module 33 secures on the application server 30 an input information storage region 60 for temporarily storing the item input information, when display of the screen has been requested. Next, in step S2, the screen generation module 33 generates screen information (an input form), based on the form definition information storage section 21 of the screen the displaying of which has been requested.

Next, in step S3, when the item input information is inputted by the WEB client 40 in the screen the displaying of which has been requested, the workflow screen control module 34 receives the item input information, and temporarily stores the item input information in the input information storage region 60. For example, input item a is stored in area a of the input information storage region 60, and input item b is stored in area b of the input information storage region 60.

Finally, the screen generation module 33 performs a logic check of the inputted item input information, based on the input information storage region 60 and the form definition information storage section 21, and stores the logic-checked item input information in the form input content storage section 24 (step S4).

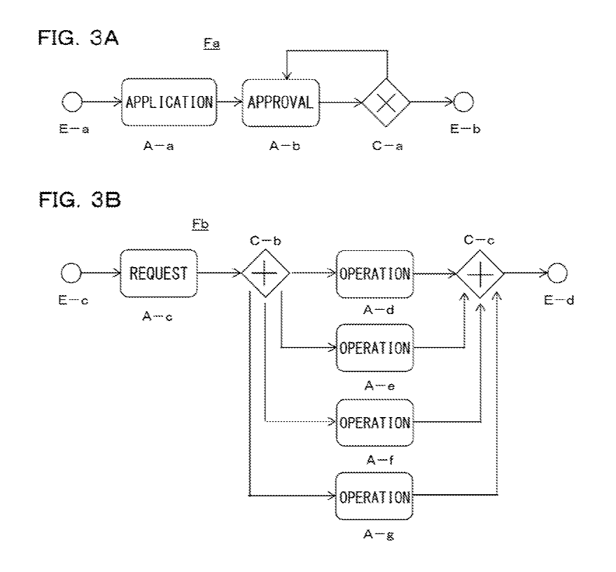

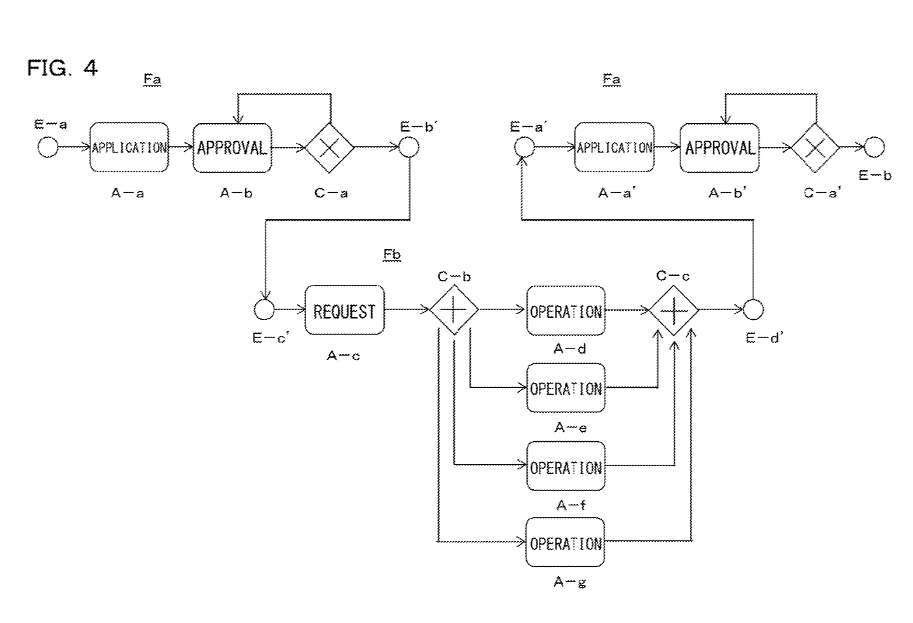

Next, a method of workflow control of the workflow implemented by the workflow engine 26 will be described with reference to FIGS. 3A to 4.

FIG. 3A is a view in which a flow processing of an approval application (hereafter, written as approval application flow Fa) is expressed by business process modelling notation (BPMN), and FIG. 3B is a view in which a flow processing of an operation request (hereafter, written as operation request flow Fb) is expressed by BPMN. FIG. 4 is a view in which a flow processing of one typical job processing, that is, a job processing A, is expressed by BPMN. The job processing A has content combining two approval application flows Fa and one operation request flow Fb.

The BPMN of FIGS. 3A to 4 are each configured from process objects and connecting lines. The process object has the following three elements, namely: an event expressing a phenomenon occurring during execution; an activity expressing an operation or processing; and a gateway performing control of branching and convergence of a sequence. In FIGS. 3A to 4, the event is expressed by a circle, the activity is expressed by a rounded rectangle, and the gateway is expressed by a diamond. Moreover, the connecting line is expressed by an arrow.

As shown in FIG. 3A, the approval application flow Fa is configured from: two activities, that is, a processing A-a (an application) and a processing A-b (an approval); two events, that is, a start E-a and an end E-b; one gateway, that is, a judgment C-a; and five connecting lines connecting each of the process objects. The judgment C-a judges an end of the processing A-b.

Similarly, as shown in FIG. 3B, the operation request flow Fb is configured from: five activities, that is, a processing A-c (a request) and a processing A-d to a processing A-g (operations); two events, that is, a start E-c and an end E-d; two gateways, that is, a parallel branch C-b and a confluence C-c; and 11 connecting lines connecting each of the process objects. The parallel branch C-b indicates the processing A-d to the processing A-g being processed concurrently after end of the processing A-c.

Moreover, as shown in FIG. 4, the job processing A has content combining the approval application flow Fa with each of front and rear of the operation request flow Fb. Therefore, the end E-b of the front stage approval application flow Fa becomes a midway E-b′, the start E-c of the operation request flow Fb becomes a midway E-c′, the end E-d of the operation request flow Fb becomes a midway E-d′, and the start E-a of the rear stage approval application flow Fa becomes a midway E-a′. Note that in FIG. 4, the rear stage approval application processing, in order for it to be distinguished from the front stage approval application processing, has its processing A-a (application) written as a processing A-a′, has its processing A-b (approval) written as a processing A-b′, and has its judgment C-a written as a judgment C-a′.

Flow control executed by the workflow engine 26, while associating a flag called a pin with a position of a next-to-be-executed process object, sequentially executes processing of the process objects positioned at the pin.

The flow processing of the job processing A shown in FIG. 4 starts from the start E-a event. At this time, a pin 1 in an execution state is generated. Next, the pin 1 is associated with the processing A-a (application) activity, and the processing A-a (application) is executed. When the processing A-a (application) ends, the pin 1 is associated with the processing A-b (approval) activity, and the processing A-b (approval) and judgment C-a are executed. When the processing A-b (approval) ends, the flow processing proceeds to the processing A-c (request) via the midway E-b′ and midway E-c′, the pin 1 is associated with the processing A-c activity, and the processing A-c (request) is executed.

When the processing A-c (request) ends, the pin 1 is associated with the parallel branch C-b gateway, and the parallel branch C-b is executed. Due to execution of this parallel branch C-b, the pin 1 is set to a suspended state, four pins 1-1 to 1-4 are newly generated to be set to execution states, the pins 1-1 to 1-4 are respectively associated with the processing A-d (operation) to processing A-g (operation) activities, and the processing A-d (operation) to processing A-g (operation) are each executed.

When the above-described processing A-d (operation) to processing A-g (operation) end, the pins 1-1 to 1-4 are associated with the judgment C-c gateway, and the judgment C-c is executed. The judgment C-c cancels the pins 1-1 to 1-4, and sets the pin 1 in the suspended state to the execution state. Then, the flow processing proceeds to the processing A-a′ (application) via the midways B-d′ and B-a′, the pin 1 is associated with the processing A-a′ (application) activity, and the processing A-a′ (application) is executed. When the processing A-a′ (application) ends, the pin 1 is associated with the processing A-b′ (approval) activity, and the processing A-b′ (approval) and judgment C-a′ are executed.

Thus, the job processing A proceeds in an order of approval application flow Fa→operation request flow Fb→approval application flow Fa. In particular, the operation request flow Fb proceeds concurrently by a plurality of persons.

As mentioned above, in the parallel branch gateway enabling execution of parallel processing, the pin in the execution state (pin 1 in FIG. 4) is set to the suspended state, and a number-of-parallel-processing amount of pins (pins 1-1 to 1-4 in FIG. 4) are newly generated to be set to execution states, whereby the plurality of pieces of processing that have undergone parallel branching in the workflow (pieces of processing A-d to A-g in the example of FIG. 4) can be parallel-processed.

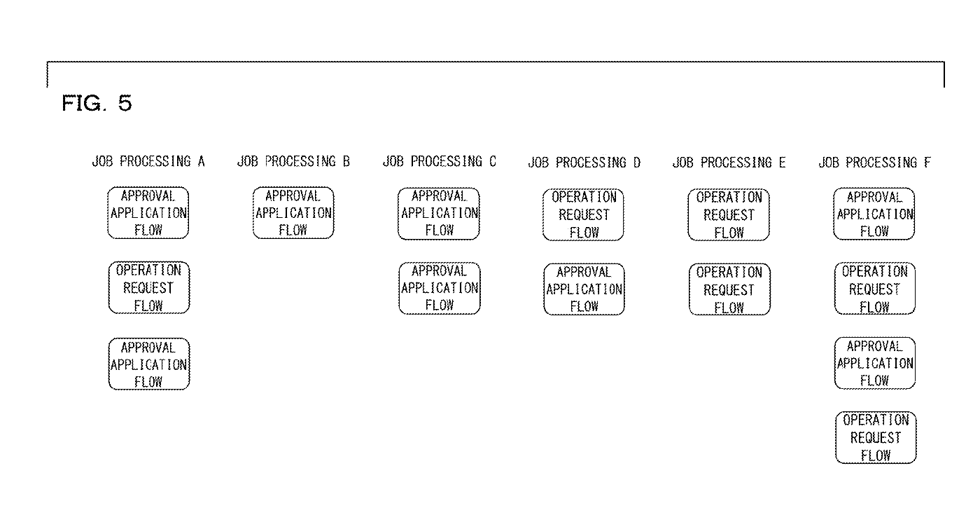

Therefore, the workflow system 10 can combine various sub-flows to construct one workflow. That is, as shown in, for example, FIG. 5, besides the approval application flow (sub-flow) and the operation request flow (sub-flow) each being processed individually, a variety of pieces of job processing such as pieces of job processing A to F can be implemented by combining in an arbitrary order one or more of the approval application flows and one or more of the operation request flows.

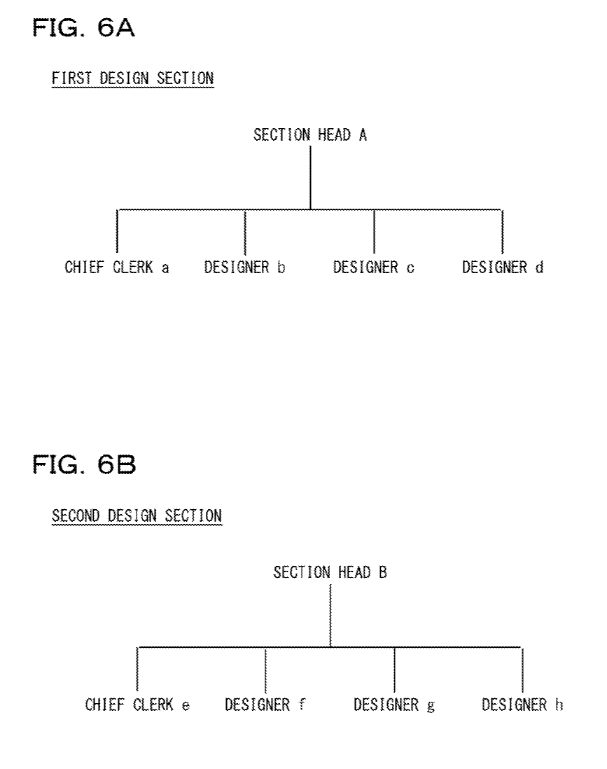

Next, specifically, a creation procedure of an approval application form and an operation request form, generation of process information, and a procedure of approval application and operation request will be described with reference to FIGS. 6A to 17.

The following may be cited as the application or request in the case of a manufacturer or the like being taken as an example, that is, for example, an approval application of a design of a new product or an improved product, an operation request after the approval has been granted (for example, a request for creation of a design drawing), and an approval application of an operation result item (for example, an approval application of the design drawing), and so on.

Accordingly, in the example below, in order to simplify explanation, the creation procedure of the approval application form and the operation request form will be described typically assuming two design departments (a first design section and a second design section).

As shown in FIG. 6A, there belong in the first design section, for example, a section head A, a chief clerk a, and designers b, c, and d, and, as shown in FIG. 6B, there belong in the second design section, for example, a section head B, a chief clerk e, and designers f, g, and h.

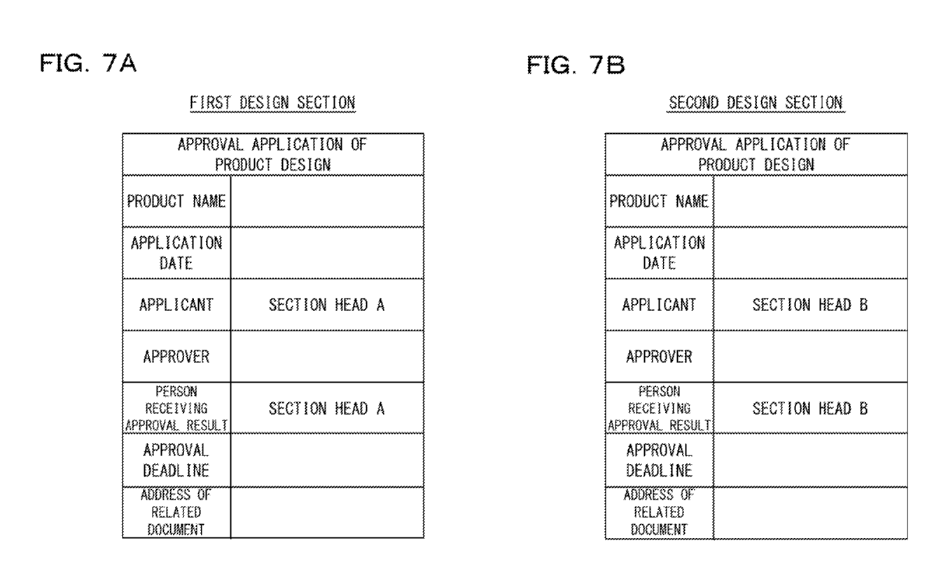

Accordingly, regarding the approval application form of the product design, it is assumed as a default that in the first design section, as shown in FIG. 7A, an applicant is the section head A, and a person receiving an approval result is the section head A. Similarly, it is assumed as a default that in the second design section, as shown in FIG. 7B, an applicant is the section head B, and a person receiving an approval result is the section head B.

Therefore, in these application forms, titles such as “approval application of product design”, “product name”, “application date”, “applicant”, “approver”, “person receiving approval result”, “approval deadline”, and “address of related document”, and names of “section head A” and “section head B” are property information of items required as the application form.

The application date, product name, approver, approval deadline, and address of related document are all determined at a time of application. Of course, the person receiving approval result may also be determined at the time of application.

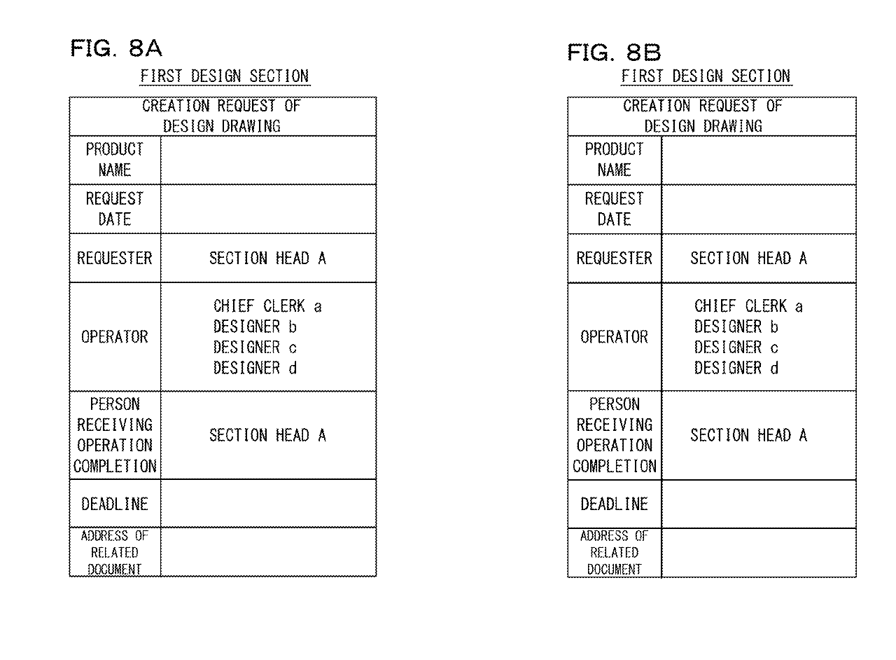

Next, regarding the creation request form of the design drawing of the product, it is assumed as a default that in the first design section, as shown in FIG. 8A, a requester is the section head A, operators are the chief clerk a and the designers b, c, and d, and a person receiving notification of operation completion is the section head A. Similarly, it is assumed as a default that in the second design section, as shown in FIG. 8B, a requester is the section head B, operators are the chief clerk e and the designers f, g, and h, and a person receiving notification of operation completion is the section head B.

Therefore, in these request forms, titles such as “creation request of design drawing”, “product name”, “request date”, “requester”, “operator”, “person receiving operation completion”, “deadline”, and “address of related document”, and names of “section head A”, “section head B”, “chief clerk a” “chief clerk e”, “designer b”, “designer c”, “designer d”, “designer f”, “designer g”, and “designer h” are property information of items required as the request form.

The request date, product name, deadline, and address of related document are all determined at a time of request. Of course, the person receiving operation completion may also be determined at the time of request.

Regarding formats of the above-described creation request forms, although in FIGS. 8A and 8B, all of the operators have been set in one operator input box, it is also possible for one operator to be set in one operator input box. In this case, a number-of-operators amount of creation request forms will be required.

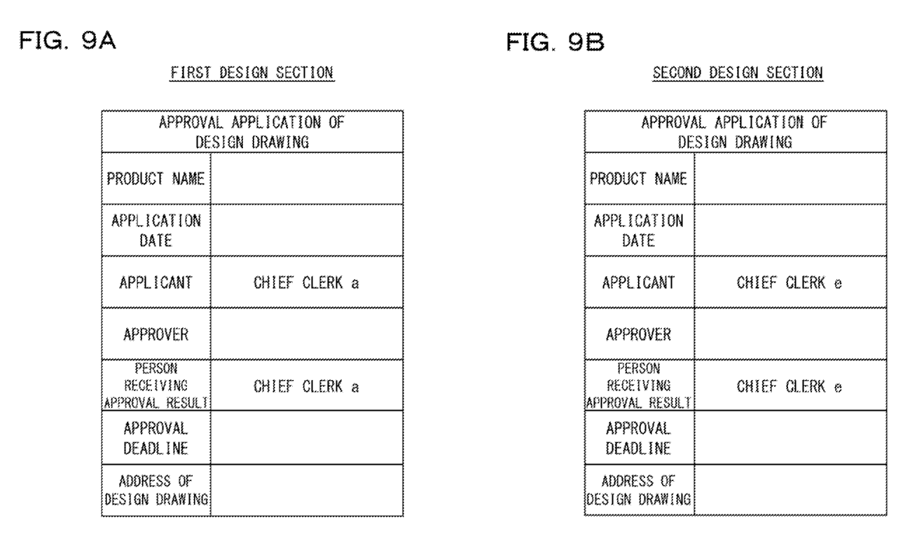

Next, regarding the approval application form of the design drawing of the first design section, it is assumed as a default that, as shown in FIG. 9A, an applicant is the chief clerk a, and a person receiving an approval result is the chief clerk a. The remaining application date, design target product name (project name, production number, and so on), approver, approval deadline, and so on, are set at a time of application, by the applicant. The same applies also to the application form of the design application of the product for the second design section (refer to FIG. 9B).

Therefore, in these application forms, titles such as “approval application of design drawing”, “product name”, “application date”, “applicant”, “approver”, “person receiving approval result”, “approval deadline”, and “address of design drawing”, and names of “chief clerk a” and “chief clerk e” are property information of items required as the application form.

The application date, product name, approver, approval deadline, and address of design drawing are all determined at a time of application. Of course, the person receiving approval result may also be determined at the time of application.

These application forms and request forms are created by an operator activating the form creation tool 31 via the WEB client 40 to input to a form creation screen displayed on a display screen of the WEB client 40 the above-mentioned items required as a default.

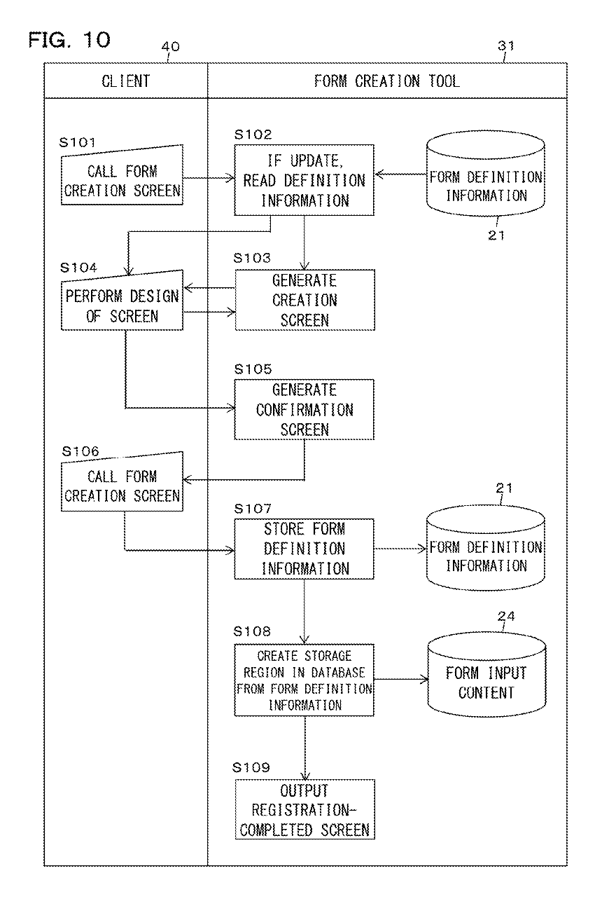

Next, creation of the application form and the request form by the form creation tool 31 will be described with reference to FIG. 10.

First, in step S101 of FIG. 10, the WEB client 40 activates the form creation tool 31 of the application server 30 via the network 50 to make a call request of the form creation screen.

Next, in step S102, when the request from the WEB client 40 is update of the form creation screen, the form creation tool 31 acquires from the form definition information storage section 21 the form definition information of the form creation screen representing an update target. Then, the form creation tool 31 generates screen information of the form creation screen based on the creation-completed form definition information, and outputs to the WEB client 40 the generated screen information of the form creation screen.

Meanwhile, in step S103, when the request from the WEB client 40 is fresh creation of the form creation screen, the form creation tool 31 generates fresh creation-oriented screen information of the form creation screen, and outputs to the WEB client 40 the generated screen information of the form creation screen.

Next, in step S104, the WEB client 40 sets the constituent elements of the application form and the request form while communicating with the form creation tool 31 via the network 50, with the form creation screen displayed by the received screen information. That is, the WEB client 40 executes screen design of the application form and the request form. In this screen design, the WEB client 40 inputs the above-mentioned property information of items required as a default, and disposition information of the items.

Next, in step S105, the form creation tool 31 generates the screen information of a confirmation screen of the application form and the request form, based on the property information and the disposition information of the constituent elements of the application form set by the WEB client 40, and outputs the generated screen information of the confirmation screen of the application form and the request form to the WEB client 40.

Next, in step S106, the WEB client 40 outputs to the form creation tool 31 a confirmation result of the confirmation screen of the application form and the request form displayed by the received screen information. At this time, the WEB client 40 displays on a screen of the WEB client 40 a display image of the created application form and request form, and sets a file name or a link name of the application form and the request form.

Next, in step S107, the form creation tool 31 stores the property information and the disposition information of the constituent elements of the confirmation-completed application form and request form, in the form definition information storage section 21, as the form definition information.

Next, in step S108, the form creation tool 31 generates in the database server 20 the form input content storage section 24 associated with the generated form definition information.

Next, in step S109, the form creation tool 31 notifies the WEB client 40 that registration of the application form and the request form has been completed, whereby creation of the application form and the request form ends.

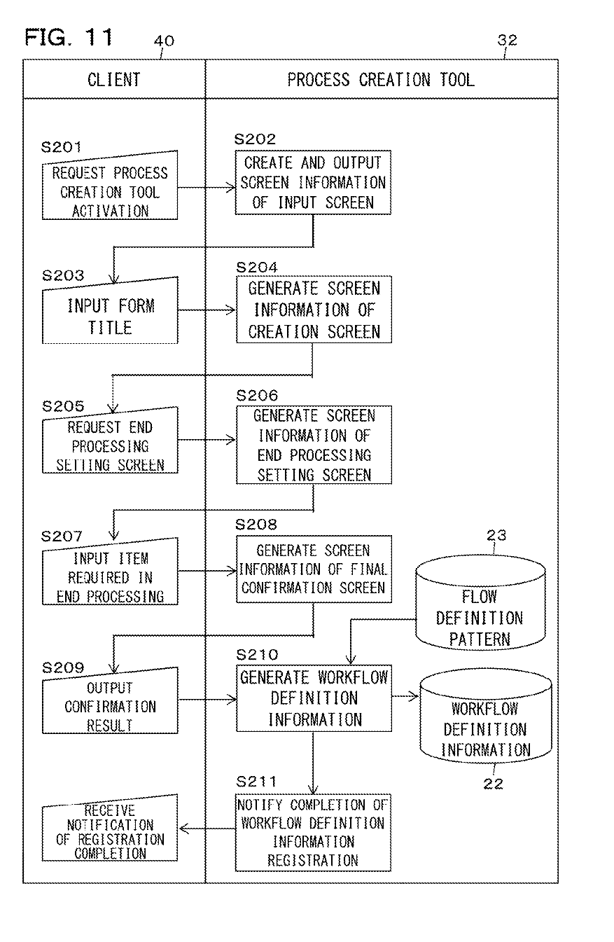

Next, the creation procedure of the flow processing of one job processing, that is, the job processing A will be described with reference to FIG. 11. FIG. 11 is a flowchart showing the creation procedure of the flow processing of the job processing A by the process creation tool 32.

First, in step S201, the WEB client 40 makes an activation request of the process creation tool 32 of the application server 30 via the network 50.

In step S202, the process creation tool 32 generates an input screen encouraging input of a title (a file name, a link name, and so on) of the application form or the request form used in the flow processing, and outputs screen information of the generated input screen to the WEB client 40.

Next, in step S203, the WEB client 40 inputs the title (file name, link name, and so on) of the form used in the flow processing, with the input screen displayed by the received screen information.

Next, in step S204, the process creation tool 32 reads the application form or the request form corresponding to the file name inputted via the input screen to generate a screen corresponding to the form, and outputs the screen information of the generated screen to the WEB client 40.

If an application form screen or a request form screen displayed by the received screen information is correct, then, in step S205, the WEB client 40 makes a request of an end processing setting screen. If the application form screen or the request form screen is not correct, then the WEB client 40 repeats the processing from step S201 onwards.

Next, in step S206, the process creation tool 32 generates the end processing setting screen, based on the request of the end processing setting screen, and outputs the screen information of the generated screen to the WEB client 40. In step S207, the WEB client 40 uses the end processing setting screen to input an item required in end processing.

End processing refers to such cases as where in the approval application, for example, in the case of approval, the applicant is notified to that effect, and if there is a next flow processing, notification to the effect of activating that next flow processing is performed whereby the approval application ends, and in the case of non-approval, persons concerned are notified to that effect whereby the approval application ends.

In the case of, for example, the approval application flow of a design of a device A in the first design section, notification of approval and notification of non-approval are made to the section head A being the applicant, and specifically in the case of approval, the operation request flow is activated. On the other hand, in the case of, for example, the approval application flow of a design drawing of the device A in the first design section, notification of approval and notification of non-approval are made to the chief clerk a being the applicant.

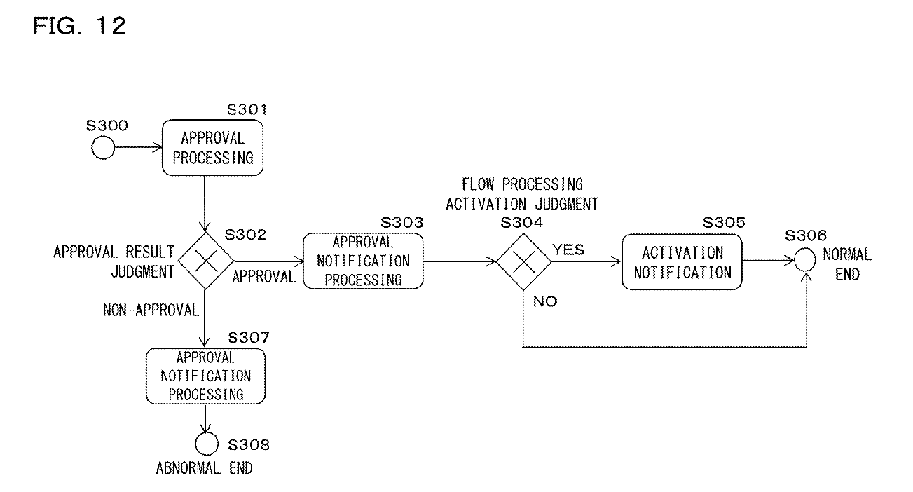

If this end processing is shown by BPMN, then, as shown in FIG. 12, the end processing starts form a start S300, an end of an approval processing S301 by the approver results in an approval result judgment processing S302 being executed, and, if a judgment result is “approval”, then an approval notification processing S303 is executed. The approval notification processing S303 notifies a preset person concerned (the applicant and so on) to the effect that approval has been granted. Then, a flow processing activation judgment processing S304 is executed, and if there is judged to be a next flow processing (for example, a request flow, or the like) (step S304: YES), then in following step S305, a notification to the effect of activating the flow processing (a flow processing activation notification processing) is executed, whereby the end processing ends by a normal end (S306). If it is judged in the above-described flow processing activation judgment processing S304 that there is not a next flow processing (step S304: NO), then the end processing ends by the normal end (S306) without the flow processing activation notification processing S305 being implemented.

If the judgment result in the above-described approval result judgment processing S302 is “non-approval”, then a non-approval notification processing S307 is executed, whereby the end processing ends by an abnormal end (S308). The non-approval notification processing S307 notifies a preset person concerned (the applicant and so on) to the effect that approval has not been granted.

On the other hand, the operation request flow may include, for example, two pieces of end processing (a first end processing and a second end processing).

The first end processing, in the case where simultaneously proceeding operations have all been completed by the deadline, notifies the requester and the operators to that effect, and if there is a next flow processing, notifies to the effect of activating that next flow processing, thereby ending. Moreover, in the case where at a time point that the deadline has elapsed, the simultaneously proceeding operations have not all been completed, the first end processing notifies the requester and the operators to that effect, thereby ending.

In the case of, for example, the operation request flow of creation of a design drawing of the device A to the first design section, notification of operation completion and notification of operation non-completion are made to the section head A being the requester, and specifically in the case of operation completion, the approval application flow of the design drawing is activated.

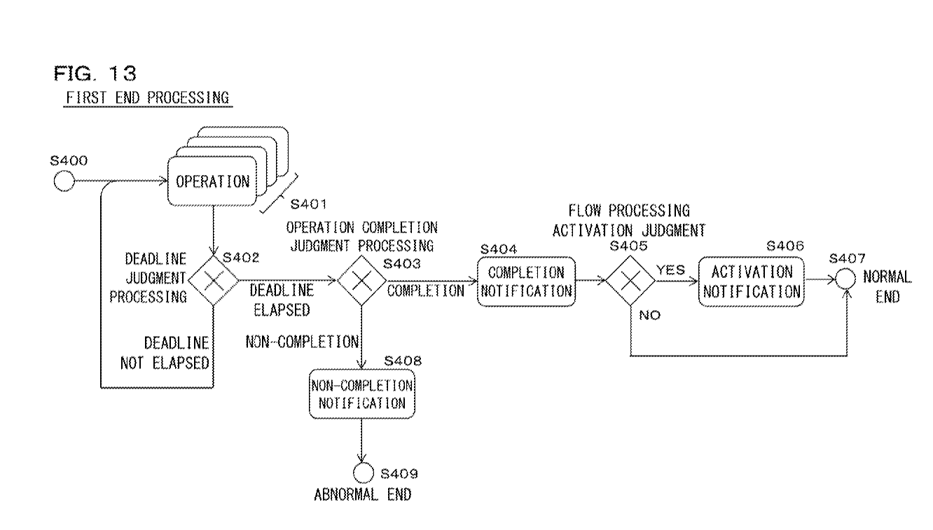

If this first end processing is shown by BPMN, then, as shown in FIG. 13, the first end processing starts form a start S400, an operations processing S401 by a plurality of the operators is started, and then, a deadline judgment processing S402 is executed. If a judgment result is “deadline not elapsed”, then the operations processing S401 is continued, and if the judgment result is “deadline elapsed”, then an operations completion judgment processing S403 is executed. If a judgment result is “completion”, then an operations completion notification processing S404 is executed. This operations completion notification processing S404 notifies a preset person concerned (the requester, and so on) to the effect that the operations have been completed. Then, a flow processing activation judgment processing S405 is executed, and if there is judged to be a next flow processing (for example, an application flow, or the like), then a notification to the effect of activating the next flow processing (a flow processing activation notification processing S406) is executed, whereby the first end processing ends by a normal end (S407). In this flow processing activation notification processing S406, notification of the address of the design drawing, and so on, is also made.

If the judgment result in the above-mentioned operations completion judgment processing S403 is “non-completion”, then an operations non-completion notification processing S408 is executed. In this operations non-completion notification processing S408, a preset person concerned (the requester, and so on) is notified to the effect that the operations have not been completed, and the first end processing ends by an abnormal end (S409).

On the other hand, the second end processing, in the case where concurrently proceeding operations have all been completed, notifies the requester and the operators of whether or not the operations have all been completed by the deadline, and if there is a next flow processing, notifies to the effect of activating that flow processing, thereby ending.

In the case of, for example, the operation request flow of creation of the design drawing of the device A to the first design section, notification of completion by the deadline or completion having exceeded the deadline is made to the section head A being the requester, and specifically in the case of completion by the deadline, the approval application flow of the design drawing is activated.

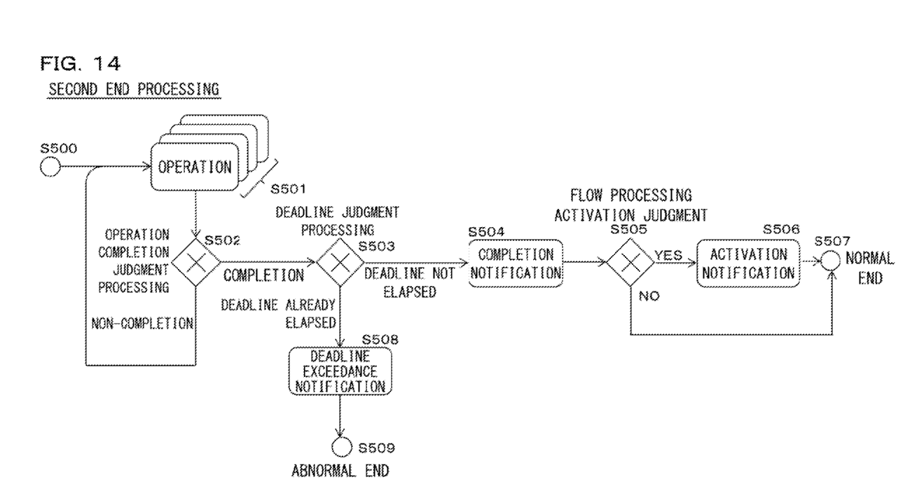

If this second end processing is shown by BPMN, then, as shown in FIG. 14, the second end processing starts form a start S500, an operations processing S501 by a plurality of the operators is started, and then, an operations completion judgment processing S502 is executed. If a judgment result is “operations incomplete”, then the operations processing is continued, and if the judgment result is “operations completed”, then a deadline judgment processing S503 is executed. If a judgment result is “deadline not elapsed”, then an operations completion notification processing S504 is executed. This operations completion notification processing S504 notifies a preset person concerned (the requester, and so on) to the effect that the operations have been completed. Then, a flow processing activation judgment processing S505 is executed, and if there is judged to be a next flow processing (for example, an application flow, or the like), then a notification to the effect of activating the next flow processing (a flow processing activation notification processing S506) is executed, whereby the second end processing ends by a normal end S507. In this flow processing activation notification processing S506, notification of the address of the design drawing, and so on, is also made.

On the other hand, if the judgment result in the deadline judgment processing S503 is “deadline already elapsed”, then a deadline exceedance notification processing S508 is executed. This deadline exceedance notification processing S508 notifies a preset person concerned (the requester, and so on) to the effect that the operations have been completed with a deadline exceedance, and the second end processing ends by an abnormal end S509.

Therefore, in setting of the end processing (S205) shown in FIG. 11, the WEB client 40, in the approval application, inputs the likes of the name of the person concerned that should be notified in the case of approval, and, if there is a next flow processing, inputs the likes of the title, symbol, or address of that flow processing. Moreover, the WEB client 40 inputs the likes of the name of the person concerned that should be notified in the case of non-approval.

The WEB client 40, in the operation request, inputs the likes of the names of the requester and the operators who are notified of completion or non-completion (completion within the deadline or exceedance of the deadline) of the operations, and, if there is a next flow processing, inputs any of the title, symbol, address, and so on, of that flow processing.

Next, in step S208 of FIG. 11, the process creation tool 32 generates screen information of a final confirmation screen for making a confirmation of content set by the WEB client 40, and outputs the generated screen information of the final confirmation screen to the WEB client 40.

Next, in step S209, the WEB client 40 outputs a confirmation result to the process creation tool 32, with a confirmation screen displayed by the received screen information. As confirmation results, there are the following, that is, for example, operating a completion button if, for example, all required items have been inputted and there is no problem, or, for example, pressing a return button if all the required items have not been inputted, and so on.

Based on operation of the completion button, in step S210, the process creation tool 32 reads from the flow definition pattern storage section 23 the flow definition pattern information of the application flow, the request application flow, and the request flow, and generates the workflow definition information of the application flow and the request flow to be stored in the workflow definition information storage section 22.

Next, in step S211, the process creation tool 32 notifies the WEB client 40 that registration of the workflow definition information of the application flow and the request flow has been completed, whereby creation of the workflow definition information related to the application flow and the request flow ends.

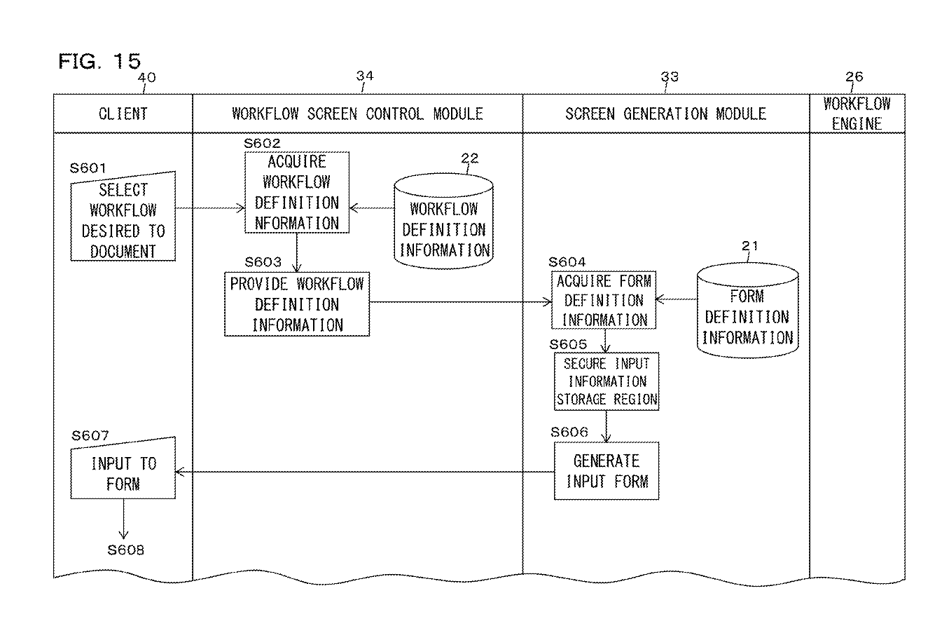

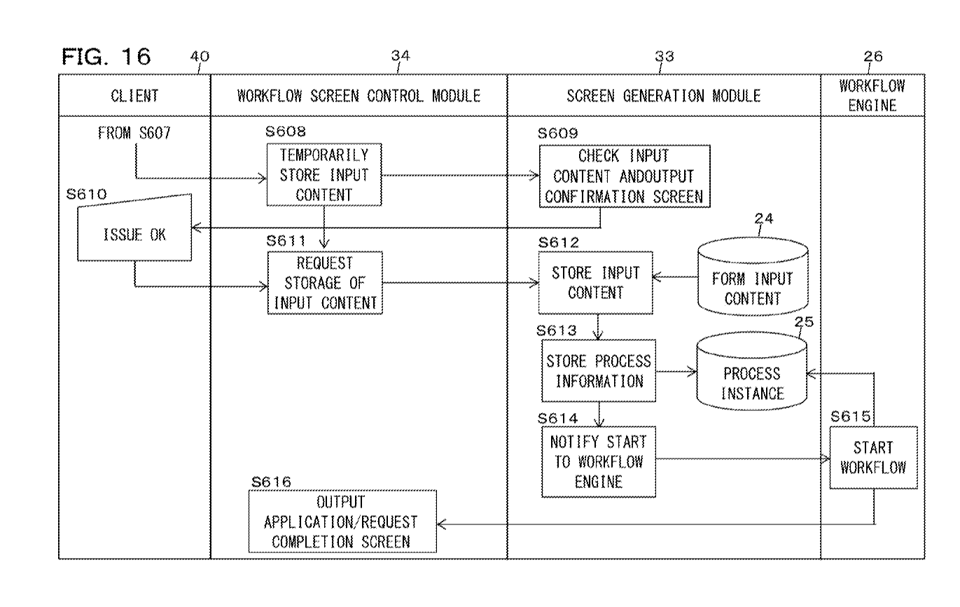

Next, an operation procedure from documentation of the workflow (the application flow and the request flow) to start of the workflow will be described with reference to FIGS. 15 and 16.

This operation is performed by the applicant and the requester. In the case of, for example, the approval application flow of the design of the device A in the first design section, of the approval application flow, the section head A performs the operation as the applicant. As an approver of the operation, there is set the likes of a department head being a superior of the section head A, for example.

Similarly, in the case of, for example, the operation request flow related to creation of the design drawing of the device A to the first design section, the section head A performs the operation as the requester.

In the case of, for example, the approval application flow of the design drawing created by the first design section, of the approval application flow, the chief clerk a performs the operation as the applicant. As an approver of the operation, there is set the likes of the section head A being a superior of the chief clerk a, for example.

Moreover, regarding a documentation application of the workflow, first, in step S601 of FIG. 15, the WEB client 40 selects the workflow to be documented, and outputs the selected information to the workflow screen control module 34 of the application server 30 via the network 50, with a displayed selection screen.

Next, in step S602, the workflow screen control module 34 acquires from the workflow definition information storage section 22 the received workflow definition information of the workflow to be documented, and provides the acquired workflow definition information to the screen generation module 33 (S603).

Next, in step S604, the screen generation module 33 acquires from the form definition information storage section 21 the form definition information of the workflow to be documented, and, based on the acquired form definition information, performs conversion to information required in generating a screen of the application form and the request form. Moreover, in step S605, the screen generation module 33 temporarily secures an input information storage region for storing all input content of the application form and the request form, and, based on the form definition information, generates screen information of the application form and the request form, and outputs the generated screen information to the WEB client 40 via the workflow screen control module 34 (S606).

Next, in step S607, the WEB client 40 inputs the item input information with the application form and the request form displayed on the screen. For example, in the case of the approval application, the WEB client 40 inputs a title indicating application content to receive approval (for example, “design application of device A”, “approval application of design drawing of device A”, and so on), the name of the approver, the approval deadline, a comment, and so on. In the case of the operation request, the WEB client 40 inputs a title indicating operation content of a request target (for example, “creation of design drawing of device A”, and so on), the deadline, a comment, and so on.

Next, in step S608, the workflow screen control module 34 stores in the input information storage region the item input information inputted by the application form and the request form, and makes a request to the screen generation module 33 for a logic check of the item input information.

Next, in step S609, based on the form definition information, the screen generation module 33 performs the logic check of the item input information secured in the input information storage region, generates screen information of a confirmation screen in order for confirmation of application content to be performed, and outputs the generated screen information to the WEB client 40 via the workflow screen control module 34.

Next, in step S610, the WEB client 40 performs confirmation of the application content (the item input information) with the confirmation screen.

Next, in step S611, the workflow screen control module 34 makes a request to the screen generation module 33 for storage of the item input information in the form input content storage section 24.

Next, in step S612, the screen generation module 33 stores the item input information in the form input content storage section 24, in step S613, stores the process information required in the application flow and the request flow in the process instance storage section 25, and, in step S614, notifies the workflow engine 26 of start of the application flow and the request flow.

Next, in step S615, the workflow engine 26 starts the approval application flow and the operation request flow, and notifies the workflow screen control module 34 that the approval application flow and the operation request flow have been started.

Next, in step S616, the workflow screen control module 34 notifies the WEB client 40 that application of the approval application flow and the operation request flow has been completed. At this stage, application of the workflow of the approval application flow and the operation request flow ends.

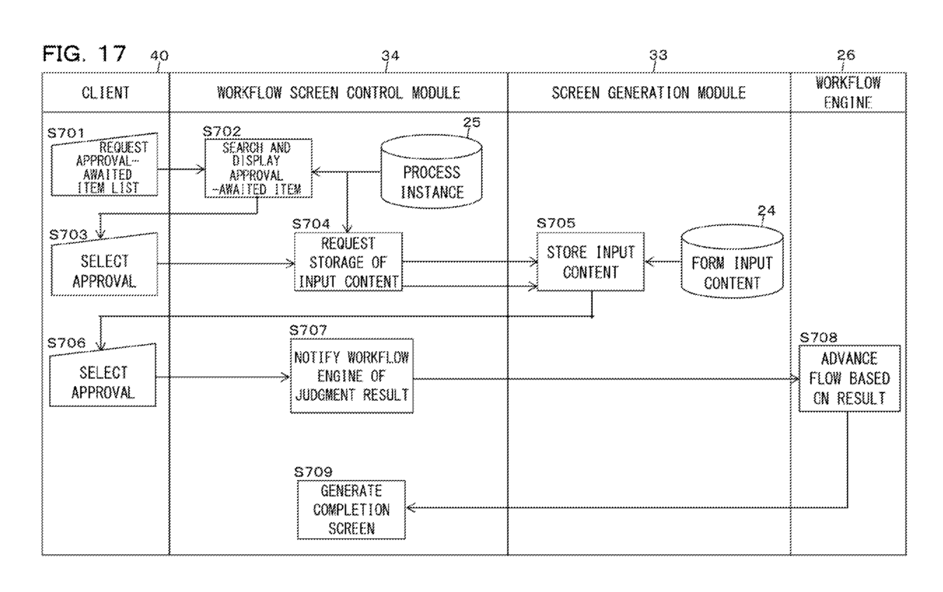

Next, an approval operation procedure of a design approval application or design drawing approval application of which application has been made will be described with reference to FIG. 17. FIG. 17 is a flowchart showing the approval operation procedure.

As shown in FIG. 17, first, in step S701, the WEB client 40 outputs to the workflow screen control module 34 a display request of an approval-awaited item list screen displaying a list of approval-awaited items.

Next, in step S702, the workflow screen control module 34 acquires from the process instance storage section 25 process information of the approval-awaited items, and outputs screen information of the approval-awaited item list screen to the WEB client 40.

Next, in step S703, the WEB client 40 selects the application to be approved, with the approval-awaited item list screen.

Next, in step S704, the workflow screen control module 34 acquires from the process instance storage section 25 process information of the selected application, and provides the acquired process information to the screen generation module 33.

Next, in step S705, based on the provided process information, the screen generation module 33 acquires the item input information from the form input content storage section 24, generates screen display information of an application content confirmation screen, and outputs the generated screen display information to the WEB client 40 via the workflow screen control module 34.

Next, in step S706, the WEB client 40 performs selection of the approval, with the displayed application content confirmation screen.

Next, in step S707, the workflow screen control module 34 notifies the workflow engine 26 of a result selected by the WEB client 40.

Next, in step S708, based on the selected result, the workflow engine 26 advances the workflow of the approval application, and notifies the workflow screen control module 34 that the approval processing has been executed.

Next, in step S709, the workflow screen control module 34 notifies the WEB client 40 that the approval operation of the approval application has been completed, whereby the approval operation of the approval application ends.

Thus, the workflow system 10 according to the present embodiment is a workflow system that is configured from the servers 20, 30, and WEB client 40, and that performs via the network 50 the job that has been set arbitrarily combining the operation flow and the approval application flow.

Moreover, the workflow system 10 includes: the workflow definition information storage section 22 that stores workflow definition information defining information for controlling the workflow; the form definition information storage section 21 that stores form definition information defining a plurality of forms employed by the workflow; the process instance storage section 25 that stores process information generated by execution of the workflow; and the workflow engine 26 that executes the workflow, based on the workflow definition information and the process information.

The workflow system 10 stores in the form definition information storage section 21 form information generated based on the form definition information, according to a constituent element and a property of a screen set by the WEB client 40, the workflow engine 26 is capable of managing an operation situation performed by the workflow, and the concurrent number of the operation flows that can be concurrently set in one workflow is able to be arbitrarily set by the WEB client 40.

As a result, the concurrent number of operation flows whose operations are simultaneously advanced by a plurality of operators (designers, and so on) can be arbitrarily set by a client, so an application range of the processing flow can be extended to various jobs, and a contribution is made to improving job furtherance.

The operation flow and the approval application flow are set by combining preset sub-flows in an arbitrary order.

As a result, by combining in an arbitrary order the approval application flows and the operation flows whose operations are simultaneously advanced by the plurality of operators (designers, and so on), a workflow can be constructed in accordance with various approvals or operations implemented by a product design, for example.

Moreover, in the workflow system 10 according to the present embodiment, the workflow definition information has included in the end processing of at least one workflow of the plurality of workflows, the activation processing of another workflow of the plurality of workflows.

Conventionally, a technique in which an approval application such as a vacation application, or the like, is performed individually, a technique in which approval applications are continued in series, and a technique in which one approval application is selected from a plurality of approval applications by an XOR junction have been main techniques, and expectations have not extended to processing flows (operation flows) whose operations are simultaneously advanced by a plurality of operators (designers, and so on).

In the present embodiment, by arbitrarily combining with the approval application flows the operation flows whose operations are simultaneously advanced by the plurality of operators (designers, and so on), the application range of the processing flow can be extended to various jobs, and a contribution is made to improving job furtherance.

In the present embodiment, the plurality of workflows include at least one approval application flow and at least one operation flow having a plurality of operations concurrently implemented.

It becomes possible that, for example, an approval application for implementing a design of a certain product is made, that, at a stage when approval has been granted, an operation request (for example, a request for creation of a design drawing, or the like) can be made to a plurality of operators (designers, and so on), and that, for example, a processing from a design approval to a request for creation of a design drawing is executed by one workflow.

In the present embodiment, the at least one operation flow and the at least one approval application flow are combined in an arbitrary order.

It becomes possible that a processing from an operation request (for example, a request for creation of a design drawing, or the like) being made to a plurality of operators (designers, and so on) to a subsequent application for verification or approval of a completed design drawing, for example, is executed by one workflow.

In the present embodiment, the workflow definition information has included in an end processing of the approval application flow an activation processing of the operation flow.

As a result, it becomes possible that the operation flow can be implemented after end of the approval application flow, and that the above-mentioned processing from design approval to the request for creation of the design drawing, for example, is executed by one workflow.

In the present embodiment, the workflow definition information has included in an end processing of the operation flow an activation processing of the approval application flow. As a result, it becomes possible that the approval application flow can be implemented after end of the operation flow, and that the above-mentioned processing from the operation request (for example, the request for creation of the design drawing, or the like) being made to the plurality of operators (designers, and so on) to the subsequent application for verification or approval of the completed design drawing, for example, is executed by one workflow.

In the present embodiment, the workflow definition information has included in an end processing of a first approval application flow an activation processing of the operation flow, and has included in an end processing of the operation flow an activation processing of a second approval application flow.

As a result, it becomes possible that a processing from an approval application for implementing a design of a certain product being made, an operation request (for example, a request for creation of a design drawing, or the like) being made to a plurality of operators (designers, and so on) at a stage when approval has been granted, and as far as an application for verification or approval of a completed design drawing, for example, is executed by one workflow.

In the present embodiment, the operation flow has a deadline set and has an end processing implemented at a stage when the deadline has elapsed.

It becomes possible that a processing such as where if, at a stage when a deadline has elapsed, an operation has ended, then, for example, an approval application on a resulting item of the operation is implemented, as a normal end, and if, at the stage when the deadline has elapsed, the operation is incomplete, then a subsequent approval application or the like is not implemented, as an abnormal end, or the like, is executed by one workflow.

In the present embodiment, the operation flow has an end processing implemented at a stage when each of the concurrently implemented plurality of operations has ended.

It becomes possible that a processing such as where if a time point when an operation has ended is within a deadline, then, for example, an approval application on a resulting item of the operation is implemented, as a normal end, and if the time point when the operation has ended is exceeding the deadline, then a subsequent approval application, or the like, is not implemented, as an abnormal end, or the like, is executed by one workflow.

Note that the present invention is not limited to the above-mentioned embodiment, and may of course by freely modified in a range not departing from the spirit of the present invention.

What is claimed is:

1. A workflow system that is configured from a server and a client and that performs via a network a job processing that includes a workflow that has been set arbitrarily combining an operation flow and an approval application flow, the workflow system comprising:
a workflow definition information storage section that stores workflow definition information defining information for controlling the workflow;
a form definition information storage section that stores form definition information defining a plurality of forms employed by the workflow;
a process instance storage section that stores process information generated by execution of the workflow; and
a workflow control unit that executes the workflow, based on the workflow definition information and the process information,
the workflow system storing in a form information storage section form information generated based on the form definition information, according to a constituent element and a property of a screen set by the client,
the workflow control unit being capable of managing an operation situation performed by the workflow, and
a concurrent number of the operation flows that can be concurrently set in one workflow being able to be arbitrarily set by the client.

2. The workflow system according to claim 1, wherein
the operation flow and the approval application flow are set by combining preset sub-flows in an arbitrary order.

3. A workflow system that is configured from a server and a client and that executes via a network a job processing that includes a plurality of workflows,
the server comprising:
a workflow definition information storage section that stores workflow definition information defining a flow processing for executing the workflow of the job processing;
a form definition information storage section that stores form definition information defining a constituent element of a screen displayed to the client during execution of the workflow;
a process instance storage section that stores process information generated by execution of the workflow;
a form input content storage section that stores item input information based on the constituent element of the screen inputted by the client during execution of the workflow;
a workflow control unit that executes the workflow, based on the workflow definition information and the process information;
a screen generation unit that generates, based on the form definition information, the process information, and the item input information, screen information of the screen of which display is requested during execution of the workflow, every time display of the screen is requested; and
a workflow screen control unit that receives the item input information that has been inputted by the client, and provides the item input information to the screen generation unit,
the workflow definition information having included in an end processing of at least one workflow of the plurality of workflows, an activation processing of another workflow of the plurality of workflows.

4. The workflow system according to claim 3, wherein
the plurality of workflows include at least one approval application flow and at least one operation flow having a plurality of operations concurrently implemented.

5. The workflow system according to claim 4, wherein
the at least one operation flow and the at least one approval application flow are combined in an arbitrary order.

6. The workflow system according to claim 4, wherein
the workflow definition information has included in an end processing of the approval application flow an activation processing of the operation flow.

7. The workflow system according to claim 4, wherein
the workflow definition information has included in an end processing of the operation flow an activation processing of the approval application flow.

8. The workflow system according to claim 4, wherein
the workflow definition information has included in an end processing of a first approval application flow an activation processing of the operation flow, and has included in an end processing of the operation flow an activation processing of a second approval application flow.

9. The workflow system according to claim 3, wherein
the operation flow has a deadline set and has an end processing implemented at a stage when the deadline has elapsed.

10. The workflow system according to claim 3, wherein
the operation flow has an end processing implemented at a stage when each of the concurrently implemented plurality of operations has ended.

11. A method of workflow control that is configured from a server and a client and that performs via a network a job that has been set arbitrarily combining an operation flow and an approval application flow, the method of workflow control comprising the steps of:
storing workflow definition information defining information for controlling a workflow;
storing form definition information defining a plurality of forms employed by the workflow;
storing process information generated by execution of the workflow; and
executing the workflow, based on the workflow definition information and the process information, and
furthermore, the method of workflow control including the steps of:
storing in a form information storage section form information generated based on the form definition information, according to a constituent element and a property of a screen set by the client; and
setting arbitrarily by the client a concurrent number of the operation flows that can be concurrently set in one workflow.

12. A method of workflow control that is configured from a server and a client and that executes via a network a job processing that includes a plurality of workflows, comprising the steps of:
storing workflow definition information defining a flow processing for executing the workflow of the job processing;
storing form definition information defining a constituent element of a screen displayed to the client during execution of the workflow;
storing process information generated by execution of the workflow;
storing item input information based on the constituent element of the screen inputted by the client during execution of the workflow;
executing the workflow, based on the workflow definition information and the process information;
generating, based on the form definition information, the process information, and the item input information, screen information of the screen of which display is requested during execution of the workflow, every time display of the screen is requested; and
receiving the item input information that has been inputted by the client, and providing the item input information,
the workflow definition information having included in an end processing of at least one workflow of the plurality of workflows, an activation processing of another workflow of the plurality of workflows.
